(19) United States
(12) Patent Application Publication
(10) Pub. No.: US 2018/0141779 A1
(43) Pub. Date: May 24, 2018

(54) LIFT CALL BUTTON WITHOUT CONTACT

(71) Applicant: Otis Elevator Company, Farmington, CT (US)

(72) Inventor: Aurelien Fauconnet, Isdes (FR)

(21) Appl. No.: 15/571,976

(22) PCT Filed: May 21, 2015
(86) PCT No.: PCT/IB2015/000966

§ 371 Date: Nov. 6, 2017

(51) Int. Cl. B66B 1/46; G06T 7/00

(52) U.S. Cl. CPC B66B 1/468; B66B 2201/4638; B66B 1/465; G06T 7/97

(57) ABSTRACT

An elevator call system including an elevator landing door (101) and a call mechanism having a projection mechanism (105a) configured to project at least one image (116, 118) onto a call zone (108) and an image detector (105b) configured to detect the at least one image (116, 118). When the image detector (105b) detects a change in the at least one image (116, 118), the call mechanism is configured to communicate with an elevator control system to request an elevator car to stop at the elevator landing door (101).

### BACKGROUND

The subject matter disclosed herein generally relates to elevator lift call buttons and, more particularly, to lift call buttons without contact.

A wide variety of elevator call buttons are known in the art. Many of these utilize micro-stroke mechanical switches, others use proximity sensing, and still others use optical patterns. However, these call buttons may have complicated mechanical structures with a large number of parts, thereby increasing costs to manufacture relative to the function served. Further, such mechanical structures may be subject to mechanical wear, and thus require maintenance and/or replacement, further increasing costs. Physical buttons may have ridges and crevices which may accumulate grime and bacteria. Additionally, these ridges and crevices may make it difficult to clean the physical buttons, preventing the complete removal of the grime and bacteria. The foregoing issues may be compounded in doctors' offices and hospitals, as well as in factories where dirty work may be performed. This is because bacteria and filth may be passed from one passenger to the button and thus to other passengers, which may be a health concern.

Traditional physical buttons require some sort of contact, even in the so-called proximity sensing types. In order to register a call, therefore, a thumb, finger, or other object must actually be targeted directly on the button. In addition to the above sanitary concerns, direct or physical contact with the button to call an elevator may be difficult when carrying bundles or when the fingers cannot be made free. Additionally, the view of the elevator call button or even one's own hands may be obscured, thus further increasing the difficulty when attempting to call an elevator. Similarly, locating the precise position of a call button so as to press or contact it may be a difficult task for the visually impaired.

Furthermore, maintenance costs for buttons with moving parts may be high due to wear and tear and the opportunity for damage due to vandalism and abuse may be increased. Additionally, the ability to tailor the aesthetic appearance of hall call buttons in order to suit architectural design may be difficult when it necessitates altering the mechanical structure thereof.

In view of the above, non-contact elevator call buttons have been developed that solve some of the above described concerns with physical elevator call buttons. These systems may be complex and require multiple sensors and complex electrical wiring and systems.

### SUMMARY

According to one embodiment an elevator call system is provided, the system including an elevator landing door and a call mechanism having a projection mechanism configured to project at least one image onto a call zone and an image detector configured to detect the at least one image. When the image detector detects a change in the at least one image, the call mechanism is configured to communicate with an elevator control system to request an elevator car to stop at the elevator landing door.

In addition to one or more of the features described above, or as an alternative, further embodiments may include that the at least one image is two images defining a first image and a second image.

In addition to one or more of the features described above, or as an alternative, further embodiments may include that the first image is at least one of (i) an arrow indicating an up direction and (ii) a text indicating an up direction.

In addition to one or more of the features described above, or as an alternative, further embodiments may include that the second image is at least one of (i) an arrow indicating a down direction and (ii) a text indicating a down direction.

In addition to one or more of the features described above, or as an alternative, further embodiments may include a processor in communication with the call mechanism and the elevator control system, the processor configured to process changes in the at least one image detected by the image detector and configured to communicate a request to the elevator control system.

In addition to one or more of the features described above, or as an alternative, further embodiments may include that the image detector is a camera.

In addition to one or more of the features described above, or as an alternative, further embodiments may include an elevator call panel having at least one physical elevator call button.

In addition to one or more of the features described above, or as an alternative, further embodiments may include that the call zone is located on a surface of a floor in front of the elevator landing door.

In addition to one or more of the features described above, or as an alternative, further embodiments may include that a width of the call zone is the same as a width of the elevator landing door.

In addition to one or more of the features described above, or as an alternative, further embodiments may include that the image detector is located at a first position relative to the elevator landing door and the projection mechanism is located at a second position relative to the elevator landing door.

In addition to one or more of the features described above, or as an alternative, further embodiments may include that the first position and the second position are the same position.

In addition to one or more of the features described above, or as an alternative, further embodiments may include that at least one of the first position and the second position is a position directly on an element of the elevator landing door.

According to another embodiment, a method of calling an elevator car without contact is provided. The method includes projecting at least one image on a call zone at least one of proximal to and on an elevator landing door, monitoring the at least one image for changes in the at least one image, and, if a change is detected in the at least one image, sending a communication to an elevator control system to request an elevator car to stop at the elevator landing door.

In addition to one or more of the features described above, or as an alternative, further embodiments may include that the at least one image is two images defining a first image and a second image.

In addition to one or more of the features described above, or as an alternative, further embodiments may include that the first image is at least one of (i) an arrow indicating an up direction and (ii) a text indicating an up direction.

In addition to one or more of the features described above, or as an alternative, further embodiments may include that the second image is at least one of (i) an arrow indicating a down direction and (ii) a text indicating a down direction.

In addition to one or more of the features described above, or as an alternative, further embodiments may include that the projecting and monitoring are made from a single position relative to the elevator landing door.

In addition to one or more of the features described above, or as an alternative, further embodiments may include that the call zone is located on a surface of a floor in front of the elevator landing door.

In addition to one or more of the features described above, or as an alternative, further embodiments may include that a width of the call zone is the same as a width of the elevator landing door.

Technical effects of embodiments of the present disclosure include non-contact elevator call buttons that require only one contactless device that is configured to enable calling an elevator car either up or down. Other technical effects include a projector and camera configuration configured to project an image, detect an indication of intent, and based on the position of the indication of intent call an elevator in the upward or downward direction.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic illustration of an elevator landing door area in accordance with an embodiment of the disclosure;

FIG. 1B is a detailed view of a contactless call button of FIG. 1A in accordance with an embodiment of the disclosure; and

FIG. 2 is a process of calling an elevator with a contactless call feature in accordance with an embodiment of the disclosure.

### DETAILED DESCRIPTION

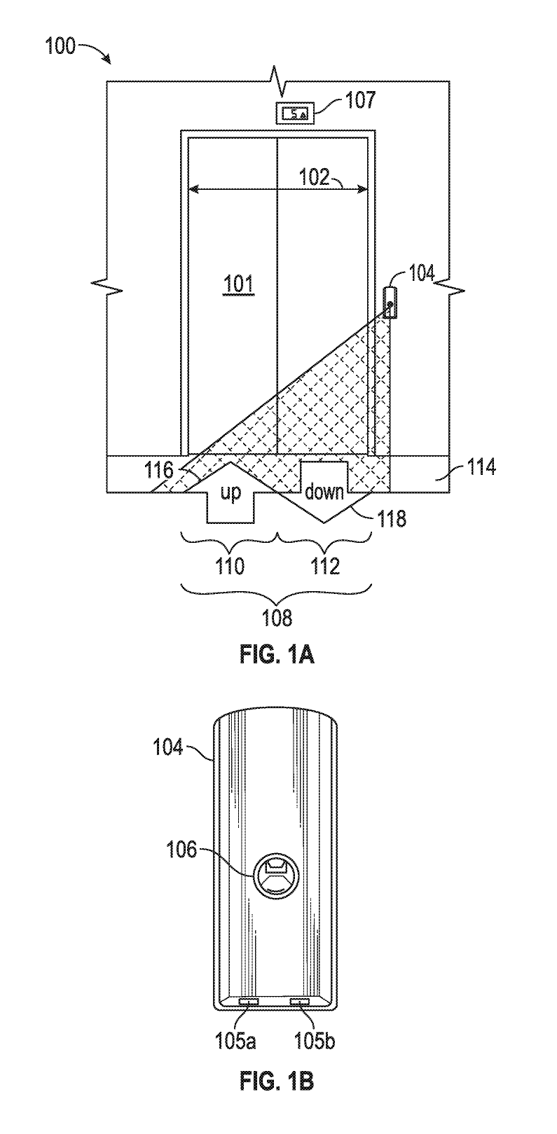

FIG. 1A is a schematic drawing of an elevator landing door area in accordance with an exemplary embodiment of the disclosure. The landing door area is an area on a floor of a building that includes an elevator that is configured to transport passengers between floors of the building. Traditionally, when a person wants to call an elevator car to move between floors, they will physically press a button that is proximal or near the elevator car door opening. As described above, physical contact with a button may be a health concern or in some situations physically contacting the button to call an elevator may be difficult.

With reference to FIG. 1A, in the landing door area 100, a landing door opening 102 is positioned relative to an elevator shaft to enable ingress and egress to and from an elevator car that is located at the landing door area 100, i.e., located at the particular floor in the building. An elevator landing door 101 may be in a closed state except when an elevator is called and located at the appropriate floor.

Proximal to the landing door opening 102 may be an elevator call panel 104. As noted, traditional call buttons are physical buttons that must be engaged manually by a user. However, in accordance with embodiments disclosed herein, no physical contact is required. Specifically, one or more images may be projected on a surface 114 before the elevator landing door 101, such as the ground or floor, and an associated camera may detect an indication of intent of a person to thus call an elevator car in a desired direction. Thus, no physical contact between the person and the elevator or related mechanisms is required by embodiments disclosed herein.

Advantageously, embodiments described herein provide a non-contact or contactless elevator call mechanism. In the embodiment shown in FIG. 1A, the elevator call panel 104 is configured with a manual call button 106 (see, e.g., FIG. 1B). In accordance with embodiments disclosed herein, the call panel 104 also includes a call mechanism having a projector or projection system 105a and a camera or image detector 105b. The projection system 105a of the call panel 104 is configured to project an image in front of the elevator landing door 101 and the image detector 105b is configured to detect the presence of an object that obstructs the image. It will be appreciated by those of skill in the art that although shown with the projection system 105a and image detector 105b as part of the call panel 104, this configuration is not limiting. For example, in some embodiments, the one or both elements of the projection and camera elements may be located anywhere on or around the landing door 101. In some embodiments, the projection system and/or image detector may be located in a position that is directly on an element of the elevator landing door (e.g., frame, lintel, column, panel, etc.), in the ceiling, in or proximate to an elevator floor/direction indicator 107 above or next to the elevator landing door, etc. In some embodiments, one or both elements of the projection and camera elements may be located directly on a portion of the elevator landing door.

Referring to FIG. 1B, a more detailed view of the elevator call panel 104 is shown. The elevator call panel 104 may include only a single central device or element in the form of the call button 106. The call button 106 may include both the projection system and the image detector described above. Thus, in some embodiments, separate physical touch buttons and projection/detection elements that are used to call an elevator may be provided in the call panel 104. In other embodiments, the call panel 104 may have a single element that is configured with a call button 106 as shown in FIG. 1B including both the projector and the detector and a physical touch aspect as well. In other embodiments, the projection system and/or the image detector may be completely separate from the panel 104, and in some embodiments, the panel 104 may be removed or eliminated, as it may be unnecessary.

In some embodiments, the projection system 105a may be configured to project the image of one or more arrows, indicating “up” or “down” directions, and/or words associated therewith. The direction of the arrow may indicate the direction to which a person desires to ride the elevator. The image detector 105b can then detect when the image of the arrow and/or word(s) are obstructed by the presence of a user that desires to call an elevator to the present floor. In other embodiments, the image detector 105b may detect the presence of a foot or other indicator in the field of view of the image detector 105b.

An illustration of the projection or image generated by the projection system 105a of the call button 106 is shown in FIG. 1A. The projection system 105a of the call panel 104 can create a call zone 108 that may include one or more areas for detection of a user's intent. A first detection area 110 and a second detection area 112, which collectively define the call zone 108, are projected by the projection system 105a onto the floor 114 in front of the landing door 101. In the first detection area 110 the projection system 105a may generate or project a first image 116 and in the second detection area 112 the projection system 105a may generate or project a second image 118. In the example shown in FIG. 1A, the first image 116 may be an arrow and associated word “up” and the second image 118 may be an arrow and associated word “down.”

As shown, the call zone 108 is configured directly in front of the elevator landing door 101, and the call zone 108 may be substantially the same width as the elevator landing door 101. The call zone 108 is divided into two areas defined by the first detection area 110 and the second detection area 112, which include different projected images 116, 118. Although shown with the call zone 108 displayed on the surface 114 located on the floor in front of the landing door 101, those of skill in the art will appreciate that the call zone 108 may be projected in other configurations, such as on the elevator door panels directly, and a user may merely move their hand or an object in front of the door panel to indicate the direction they wish to travel.

It will be appreciated that on the lowest level only an “up” image may be projected and on the highest floor only a “down” image may be projected onto the floor in front of the elevator landing door. However, on each floor between the lowest and highest floors, the projection system 105a may be configured to project both an “up” image and a “down” image, thus allowing a person to call an elevator in either direction. The calling of an elevator car will be described below, with respect to the configuration shown in FIG. 1A.

In operation, the projection mechanism 105a of the call panel 104 is configured to project the image(s) onto the ground or floor 114 in front of the elevator landing door 101. When a person desires to call an elevator, the person will place their foot over or on the arrow of the direction they would like to travel. With the foot placed over the image (116, 118), the image detection device 105b (e.g., a camera) will detect the presence of the foot or an object over the image (116, 118) and call an elevator in the direction indicated by the person. The calling of the elevator is enabled by the call mechanism being configured in communication with an elevator controller (not shown). That is, the call mechanism, including the projection system 105a and image detector 105b, is configured to communicate to an elevator controller to indicate to the elevator controller that a person has called the elevator. The communication between the call mechanism and the elevator controller may be by any means, such as a wired communication and/or a wireless communication.

The projection system 105a and the image detector 105b are configured to operate together to enable a display of an image and detection of a user's intent. That is, the image detector 105b may include processing components and/or software configured to detect a change in the received image that is projected by the projection system 105a. For example, when there is no user present, the image detected by the image detector may be constant and may include pixels representative of the arrow and/or words that are displayed on the ground. However, when a user wants to call an elevator for traveling between floors, the user may place their foot, their body, and/or some other object over the image on the floor that is representative of the direction the user wants to travel. In some embodiments, the placement of the body part or other object may only be required for a few seconds or other short period of time, and there may be no requirement or need to stay over the desired projected image. The placement of the body part or object will disrupt or change the image received by the image detector. When the image is disrupted or changed, the processing unit or components of the image detector may trigger a request to be sent to an elevator control system or other communication may be made to the elevator control system. The request will indicate to the elevator control system that a user is present on the particular floor and indicate the direction the user has indicated they would like to travel. The elevator control system may then stop an appropriate elevator car at the floor.

In alternative embodiments, in addition to a direction indication for calling an elevator, the projection system may additionally display the available floor numbers, and a user can indicate which floor they desire to travel to. That is, a user could indicate not only that they want to go upward but also indicate the floor they want get to. In other embodiments, the arrows and directions indicated above may be omitted and replaced by indicators of the available floors. As such, a user may indicate that the user is calling an elevator that is traveling upward or downward based on the specific floor that is desired. Advantageously, in these embodiments, the elevator may be instructed to travel to a desired floor based on the indication by the user when they approach the elevator landing door, and thus a user may not need to press any buttons once within the elevator car.

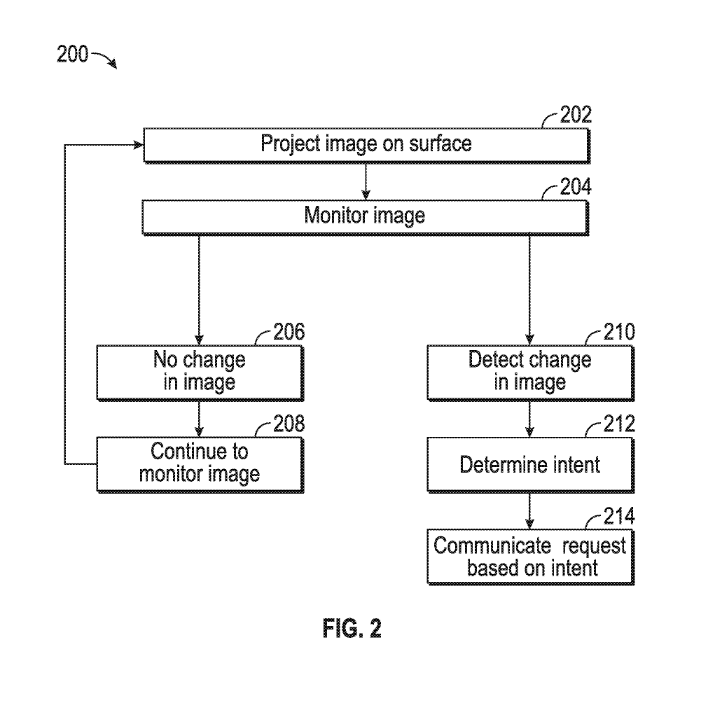

Turning now to FIG. 2, a process in accordance with an embodiment of the disclosure is shown. Process 200 operates similar to that described above, and incorporates similar elements and features. As a first step, which may be continuous throughout the process 200, at step 202 an image is projected onto a surface, such as a floor, a mat, or other space or area that is in front of an elevator landing door. A projection system and/or image detector may be located where traditional call buttons may be located or may be located in some other location, such as above the elevator landing door, in or on the ceiling, or in some other location/configuration. Further, as noted above, the location of the projection system and image detector may be at one location, or one element may be located remote from the other to enable a desired effect, such as optimal image projection and optimal image obstruction capture by the image detector.

At step 204, which may also be continuous throughout process 200, an image detector, such as a camera, may monitor the image projected at step 202. The image detector, and any associated software and/or hardware, may be configured to detect changes in the image projected at step 202. At step 206, if a change is not detected, then at step 208, the system may be configured to continue to monitor the image, and as such, may return to step 204.

However, if during step 204 a change is detected in the projected image, such as at step 210, the system may perform an elevator call. Thus, at step 212 the system may determine an intent of a user. That is, based on the change that is detected at step 210, the system may determine if a user desires to travel upward or downward in an elevator car. Once it is determined at step 212 which direction a user intends to travel, a request may be made to an elevator control system at step 214. The determination of the intent may be based on which portion or image within a call zone a user has impacted and thus changed, as described above.

Advantageously, embodiments described herein permit a single device to be configured to determine an “up” or “down” call of an elevator without any contact from a user. Further, advantageously, cleanliness may be improved in elevator systems by eliminating the need for a user to physically contact a button or other device. This may decrease the possibility of transfer of contaminants, etc. such as in a hospital. Furthermore, advantageously, embodiments disclosed herein enable a user to call an elevator even when the user's hands may be full, such as filled with grocery, moving furniture, etc.

Furthermore, advantageously, the projection of an image indicating an arrow for direction and/or an associated word or words may enable simple use of a contactless elevator call system. Moreover, the projection of the image in front of the elevator landing door may enable implementation in small spaces, such as at the end of a hallway, or other space where there is limited space around an elevator door, or other features are present in the architecture.

Furthermore, the use of a single device enables a simple construction that may easily be incorporated into existing systems without the need for additional wiring, controls, etc. For example, embodiments of the contactless call button described herein may merely replace existing physical call button panels, and wire into the same control communication that the prior physical call buttons employed.

Moreover, advantageously, in accordance with some embodiments, a back-up or redundant system having physical touch buttons may be employed in addition to the projector-camera systems described herein. For example, in such systems and configurations, operation of elevators may not be hampered in any way by certain users, including handicapped or disabled persons.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although shown here with having only the projector-camera configuration for calling an elevator, those of skill in the art will appreciate that the call button panel may incorporate physical call buttons or other call devices in addition to the projector-camera system described herein. Moreover, although described with two different call areas, one for “up” and one for “down,” it will be appreciated that both of the areas may be configured to call for the same direction, such as for a system on the lowest floor or the highest floor along an elevator shaft. In other embodiments, the highest floor may have a single down indicator, and no indication or space used for up, and the lowest floor may have single up indicator, and no indication or space used for down.

Accordingly, the present disclosure is not to be seen as limited by the foregoing description, but is only limited by the scope of the appended claims.

1. An elevator call system, the system comprising:
an elevator landing door; and
a call mechanism having a projection mechanism configured to project at least one image onto a call zone and an image detector configured to detect the at least one image;
wherein when the image detector detects a change in the at least one image, the call mechanism is configured to communicate with an elevator control system to request an elevator car to stop at the elevator landing door.

2. The system of claim 1, wherein the at least one image is two images defining a first image and a second image.

3. The system of claim 2, wherein the first image is at least one of (i) an arrow indicating an up direction and (ii) a text indicating an up direction.

4. The system of claim 2, wherein the second image is at least one of (i) an arrow indicating a down direction and (ii) a text indicating a down direction.

5. The system of claim 1, further comprising a processor in communication with the call mechanism and the elevator control system, the processor configured to process changes in the at least one image detected by the image detector and configured to communicate a request to the elevator control system.

6. The system of claim 1, wherein the image detector is a camera.

7. The system of claim 1, further comprising an elevator call panel having at least one physical elevator call button.

8. The system of claim 1, wherein the call zone is located on a surface of a floor in front of the elevator landing door.

9. The system of claim 8, wherein a width of the call zone is the same as a width of the elevator landing door.

10. The system of claim 1, wherein the image detector is located at a first position relative to the elevator landing door and the projection mechanism is located at a second position relative to the elevator landing door.

11. The system of claim 10, wherein the first position and the second position are the same position.

12. The system of claim 10, wherein at least one of the first position and the second position is a position directly on an element of the elevator landing door.

13. A method of calling an elevator car without contact, the method comprising:
projecting at least one image on a call zone at least one of proximal to and on an elevator landing door;
monitoring the at least one image for changes in the at least one image; and
if a change is detected in the at least one image, sending a communication to an elevator control system to request an elevator car to stop at the elevator landing door.

14. The method of claim 13, wherein the at least one image is two images defining a first image and a second image.

15. The method of claim 14, wherein the first image is at least one of (i) an arrow indicating an up direction and (ii) a text indicating an up direction.

16. The method of claim 13, wherein the second image is at least one of (i) an arrow indicating a down direction and (ii) a text indicating a down direction.

17. The method of claim 13, wherein the projecting and monitoring are made from a single position relative to the elevator landing door.

18. The method of claim 13, wherein the call zone is located on a surface of a floor in front of the elevator landing door.

19. The method of claim 18, wherein a width of the call zone is the same as a width of the elevator landing door.
